(19) United States
(12) Patent Application Publication
(10) Pub. No.: US 2026/0089550 A1
(43) Pub. Date: Mar. 26, 2026

(54) ARTIFICIAL INTELLIGENCE/MACHINE LEARNING (AI/ML) INTEGRATION IN WI-FI

(71) Applicant: MaxLinear, Inc., Carlsbad, CA (US)

(72) Inventor: Saju Palayur, Poway, CA (US)

(73) Assignee: MaxLinear, Inc., Carlsbad, CA (US)

(21) Appl. No.: 19/342,405

(22) Filed: Sep. 26, 2025

Related U.S. Application Data
(60) Provisional application No. 63/699,312, filed on Sep. 26, 2024.
(60) Provisional application No. 63/703,195, filed on Oct. 3, 2024.

(51) Int. Cl. H04W 28/02; H04L 47/2408; H04W 84/12

(52) U.S. Cl. CPC H04W 28/0268; H04L 47/2408; H04W 84/12

(57) ABSTRACT

An access point (AP) may include a processing device. The processing device may generate, at the AP, a training set including historical downstream traffic; train, at the AP, a neural network using the training set; receive, at the AP, downstream traffic; and classify, at the AP, the downstream traffic using the neural network.

### RELATED APPLICATIONS

This application claims the benefit of U.S. Provisional Application No. 63/699,312, filed Sep. 26, 2024, and U.S. Provisional Application No. 63/703,195, filed Oct. 3, 2024, the disclosures of which are each incorporated herein by reference in their entireties for all purposes.

The examples discussed in the present disclosure are related to artificial intelligence and machine learning integration in Wi-Fi®.

### BACKGROUND

Unless otherwise indicated herein, the materials described herein are not prior art to the claims in the present application and are not admitted to be prior art by inclusion in this section.

Institute of Electrical and Electronics Engineers (IEEE) 802.11 standards include protocols for implementing wireless local area network (WLAN) communications, including Wi-Fi®. Enhanced reliability and low latency may be used in wireless local area networks (WLANs).

The subject matter claimed in the present disclosure is not limited to examples that solve any disadvantages or that operate only in environments such as those described above. Rather, this background is only provided to illustrate one example technology area where some examples described in the present disclosure may be practiced.

### SUMMARY

An access point (AP) may include a processing device. The processing device may generate, at the AP, a training set including historical downstream traffic; train, at the AP, a neural network using the training set; receive, at the AP, downstream traffic; and classify, at the AP, the downstream traffic using the neural network.

An AP may include a processing device. The processing device may generate, at the AP, a training set including channel condition patterns; train, at the AP, a neural network using the training set; and select, at the AP, one or more channels using the neural network to minimize interference and maximize data throughput.

An AP may include a processing device. The processing device may receive, at the AP, a user request relating to network performance of one or more of a device or an application; identify, at the AP, the one or more of the device or the application; generate, at the AP, a training set relating to the network performance of one or more of the device or the application; train, at the AP, a model using the training set; and generate, at the AP, an increase in network performance of one or more of the device or the application using the model.

The objects and advantages of the examples will be realized and achieved at least by the elements, features, and combinations particularly pointed out in the claims.

Both the foregoing general description and the following detailed description are given as examples and are explanatory and are not restrictive of the invention, as claimed.

### BRIEF DESCRIPTION OF THE DRAWINGS

Examples will be described and explained with additional specificity and detail through the use of the accompanying drawings in which:

FIG. 1 illustrates an example wireless network for traffic prioritization.

FIG. 2 illustrates an example downstream traffic flow in a wireless network.

FIG. 3 illustrates an example downstream traffic flow in a wireless network for traffic prioritization.

FIG. 4A illustrates an example graphical user interface for traffic prioritization.

FIG. 4B illustrates an example graphical user interface for traffic prioritization.

FIG. 4C illustrates an example diagram for automated self-guided troubleshooting.

FIG. 5 illustrates an example of smart channel selection.

FIG. 6 illustrates a block diagram of an example system configured to perform AI/ML integration.

FIG. 7 illustrates an example process flow of AI/ML integration.

FIG. 8 illustrates an example process flow of AI/ML integration.

FIG. 9 illustrates an example process flow of AI/ML integration.

FIG. 10 illustrates an example process flow of AI/ML integration.

FIG. 11 illustrates an example process flow of AI/ML integration.

FIG. 12 illustrates a diagrammatic representation of a machine in the example form of a computing device within which a set of instructions, for causing the machine to perform any one or more of the methods discussed herein, may be executed.

### DESCRIPTION

Artificial Intelligence/Machine Learning (AI/ML) integration in Wi-Fi® routers may enhance network performance and security, automate management, and improve user experience by adapting to usage patterns. It may ensure efficient device connectivity, offer predictive maintenance, and may lead to cost savings through optimized resource utilization. This results in more reliable, personalized, and efficient connectivity.

Traffic prioritization may be difficult to implement in wireless local area networks. In some examples, high-priority traffic (e.g., video streaming) may not be marked correctly as high-priority traffic. Furthermore, selecting a channel may be difficult because searching through the available channels can be time-consuming. In addition, interfacing with an access point may be difficult because of the terminology involved. Therefore, devices, systems, and methods for integrating artificial intelligence and machine learning for enhancing efficiency may be useful.

In one example, an access point may include a processing device which may: generate, at the AP, a training set including historical downstream traffic; train, at the AP, a neural network using the training set; receive, at the AP, downstream traffic; and classify, at the AP, the downstream traffic using the neural network.

In another example, an access point may include a processing device which may: generate, at the AP, a training set including channel condition patterns; train, at the AP, a neural network using the training set; and select, at the AP, one or more channels using the neural network to minimize interference and maximize data throughput.

In another example, an access point may include a processing device which may: receive, at the AP, a user request relating to network performance of one or more of a device or an application; identify, at the AP, the one or more of the device or the application; generate, at the AP, a training set relating to the network performance of one or more of the device or the application; train, at the AP, a model using the training set; and generate, at the AP, an increase in network performance of one or more of the device or the application using the model.

Examples of the present disclosure will be explained with reference to the accompanying drawings.

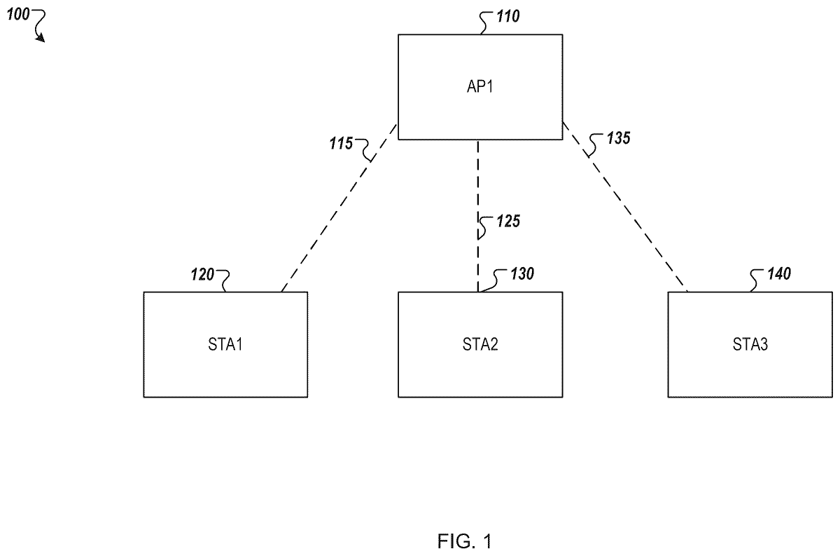

FIG. 1 illustrates an example wireless network 100 for traffic prioritization including an access point (AP) and various stations (STAs). AP1 110 may be coupled to STA1 120 via connection 115, to STA2 130 via connection 125, and/or to STA3 140 via connection 135. The different STAs may use different applications. STA1 120 may use a meeting application which may use audio and/or video. STA2 130 may use a file transfer application. STA3 140 may use an augmented reality/virtual reality gaming application.

Modifications, additions, or omissions may be made to the components of FIG. 1 without departing from the scope of the present disclosure.

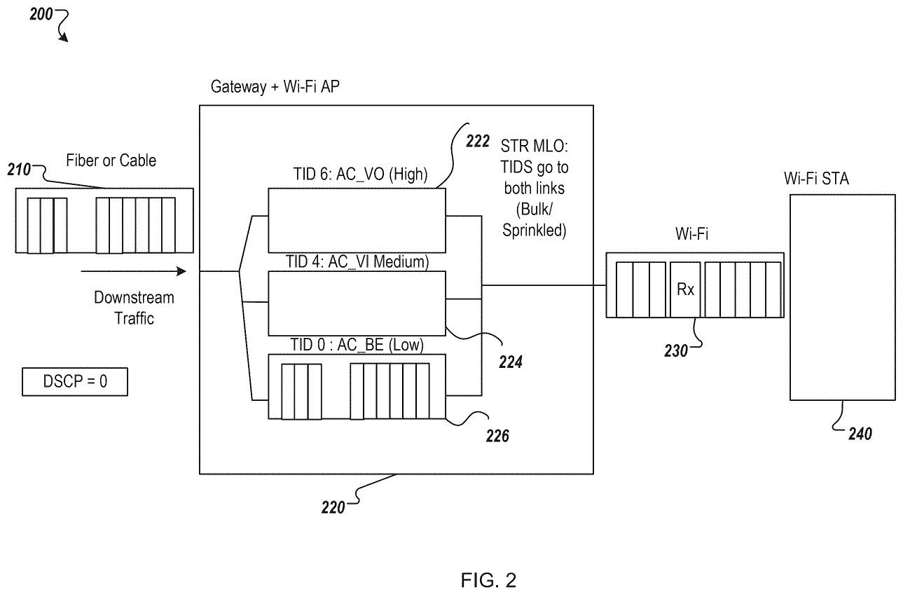

FIG. 2 illustrates an example of downstream traffic flow in a Wi-Fi® network 200. A connection 210 (e.g., fiber or cable) may carry downstream traffic to a gateway and Wi-Fi® access point (AP) 220. The AP 220 may carry downstream traffic that may be classified into three queues: (i) traffic identifier (TID) 0 which may be access category best efforts (AC_BE) for low priority traffic 226, (ii) TID 4 which may be access category video (AC_VI) for medium priority traffic 224, and (iii) TID 6 which may be access category voice (AC_VO) for high priority traffic 222. The TIDs may go to one or both links. That is, the links may be bulk or sprinkled. The downstream traffic may be communicated to a Wi-Fi® STA 240 via a Wi-Fi® packet 230. The downstream traffic may be sent as low priority 226 because the differentiated services code point (DSCP) may be incorrectly marked. This may lead to a lack of correct packet prioritization.

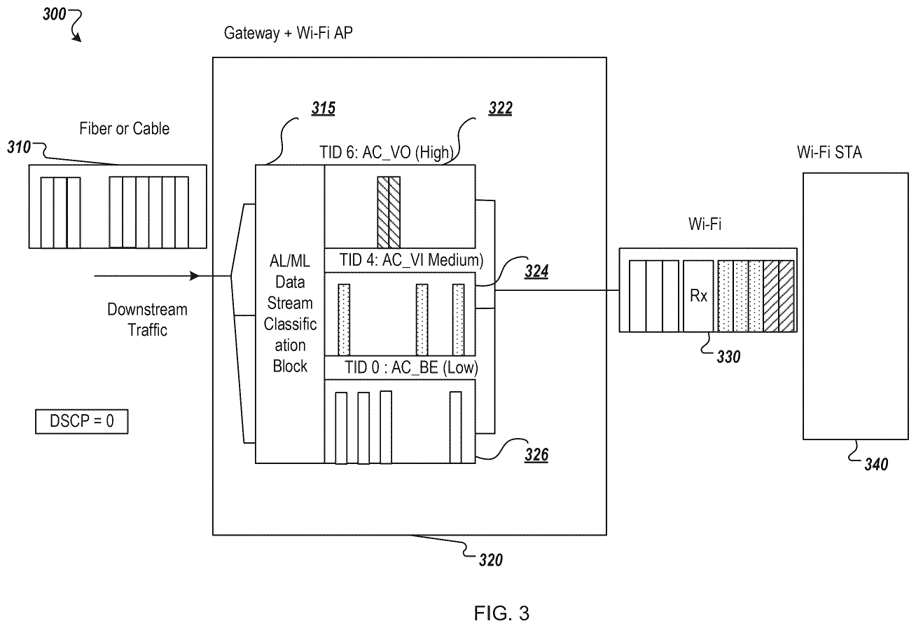

As illustrated in FIG. 3, artificial intelligence/machine learning (AI/ML)-based traffic prioritization may help to learn and restamp DSCP based on real-time traffic characteristics for optimal prioritization. Adaptive DSCP restamping may adjust traffic priorities based on evolving network conditions. The user may override the default restamped prioritization if the user would like to lower the priority of some video streams.

Application prioritization may be implemented. Users may assign priority to certain applications, ensuring that high-priority tasks (e.g., video calls or online gaming) get bandwidth even during times of network congestion. This allows certain activities to receive the best possible network performance.

In FIG. 3, the quality of service (QoS) hardware queues are properly filled, enabling the video packets to be sent at higher priority. In this example of downstream traffic flow in a Wi-Fi® network 300, downstream traffic may be communicated from a connection 310 (e.g., fiber or cable) to a Gateway and Wi-Fi® AP 320. The downstream traffic may be communicated to an AI/ML data stream classification block 315. The AI/ML data stream classification block may classify the downstream traffic into various hardware queues including: (i) TID 0 which may be AC_BE for low priority traffic 326, (ii) TID 4 which may be AC_VI for medium priority traffic 324, and (iii) TID 6 which may be AC_VO for high priority traffic 322. The downstream traffic, as sent to different hardware queues, may be transmitted as a Wi-Fi® packet 330 to a Wi-Fi® STA 340.

An access point (AP) may be used with an AL/ML data stream classification block. The AP may include a processing device. The processing device may receive, at the AP, downstream traffic. The processing device may determine, at the AP, a traffic characteristic for the downstream traffic. The processing device may restamp, at the AP, a DSCP based on the traffic characteristic to generate a restamped DSCP. The processing device may select, at the AP, a data stream classification based on the restamped DSCP.

The processing device may adjust the data stream classification based on input from a user. The processing device may adjust the data stream classification based on a network condition. The downstream traffic may be received via one or more of a fiber or a cable. The processing device may generate a wireless signal for transmission using the data stream classification. The data stream classification may be selected using a TID.

The traffic characteristic may be determined using artificial intelligence and/or machine learning. For example, the traffic characteristic may be determined by collecting a data set; and training a model using the data set. Various approaches may be used including one or more of: supervised learning, unsupervised learning, reinforcement learning, or the like. Types of supervised learning may include active learning, classification, and/or regression. Types of unsupervised learning may include clustering, dimensionality reduction, and density estimation. Various types of models may be used including artificial neural networks, decision trees, support-vector machines, regression analysis, Bayesian networks, Gaussian processes, genetic algorithms, belief functions, or the like.

A STA may be used with the AL/ML data stream classification block. The STA may include a processing device. The processing device may receive, at the STA from an access point (AP), downstream traffic that has a restamped DSCP.

The downstream traffic may be classified using a neural network. For example, the access point may include a processing device that may generate a training set including historical downstream traffic. The processing device may train the neural network using the training set (which may include the historical downstream traffic). The processing device may receive the downstream traffic and classify the downstream traffic using the neural network.

The neural network may be any suitable neural network. For example, the neural network may be one or more of a convolutional neural network (CNN), a long short-term memory (LSTM) recurrent neural network (RNN), or the like. The neural network may be used to predict the quality of service (QoS) for the downstream traffic. By predicting the QoS for the downstream traffic, the neural network may enhance performance of the downstream traffic e.g., by reducing the latency, increasing the throughput, or the like.

The neural network may be trained to detect anomalies in the downstream traffic. For example, an anomaly in the downstream traffic may be detected by reconstructing the downstream traffic and using the reconstruction error to detect the anomaly. The detection of an anomaly may be an indication that the downstream traffic has a security problem.

The neural network may be trained to determine power consumption and to reduce power consumption. For example, a processing device may predict power consumption based on the downstream traffic to generate the predicted power consumption. The processing device may adjust the power consumption based on the predicted power consumption. This may allow for reduced power consumption.

The neural network may receive input from a user to prioritize certain applications. For example, a user may request that the AP enhance the performance of a video sharing application. The neural network may use this request to enhance the network performance for the video sharing application.

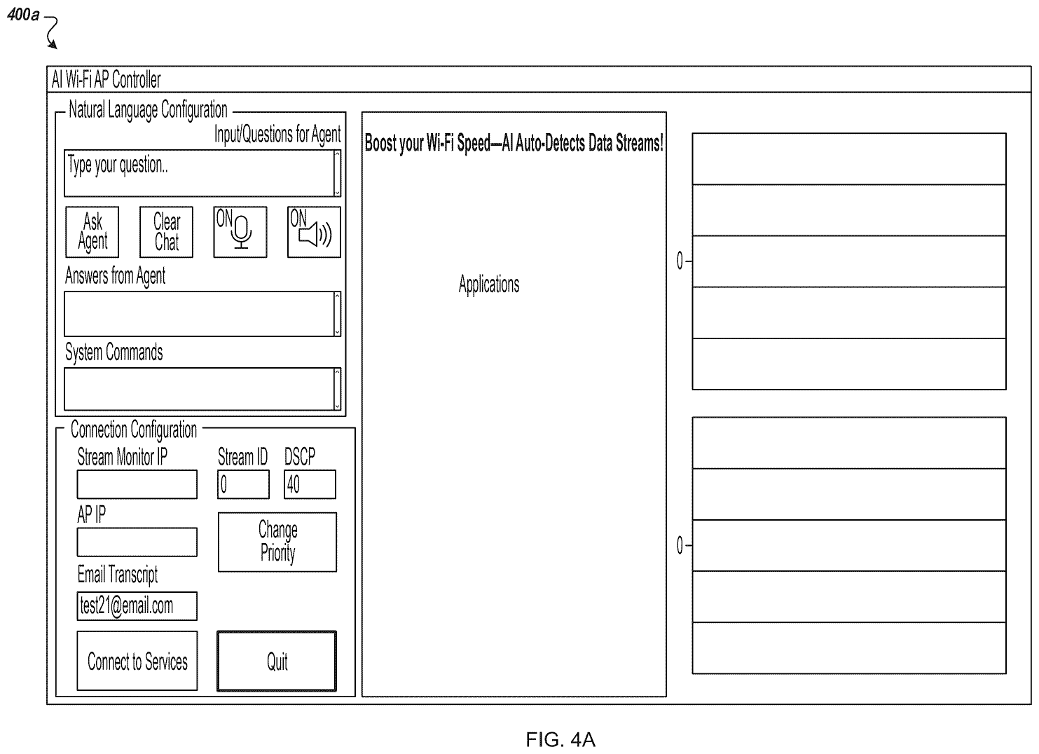

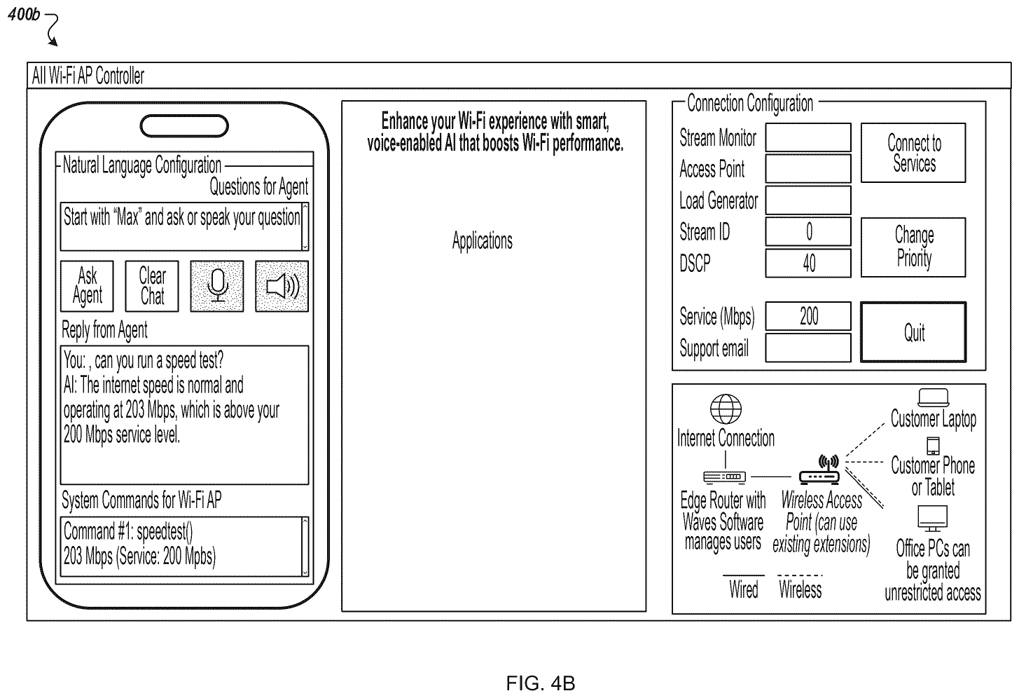

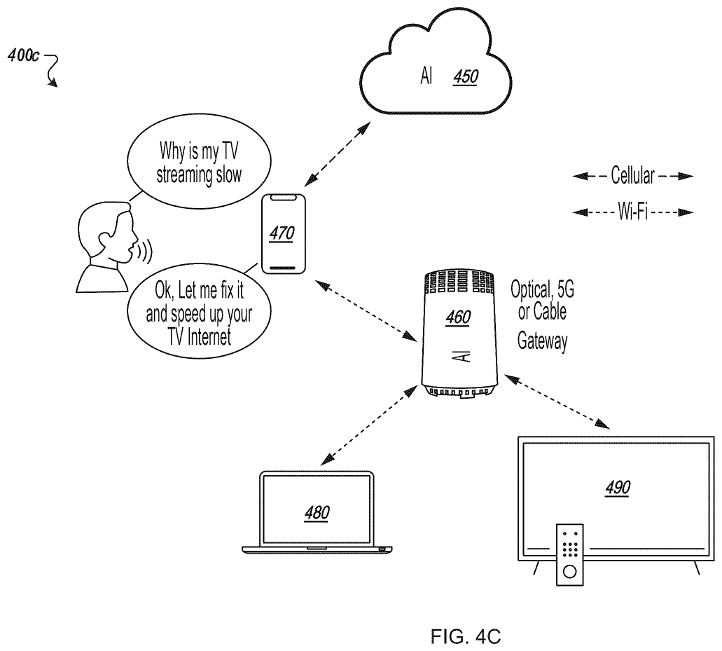

FIG. 4A illustrates a graphical user interface (GUI) 400a. The graphical user interface 400a may include various sections including: (i) a natural language configuration section, (ii) a connection configuration section, (iii) a central section, and/or (iv) a graph section. The natural language configuration section may include a sub-section that has input/questions for an agent with various buttons such as “ask agent,” “clear chat,” “microphone ON,” and “sound on.” The natural language configuration section may include a subsection showing answers from the agent. The natural language configuration section may include a systems commands section.

The graphical user interface 400a may include a connection configuration section that may include one or more of: (i) stream monitor internet protocol (IP), (2) AP IP, (3) email Transcript, (iv) stream ID, and (v) DSCP. Buttons used may include “connect to services,” “change priority,” and “quit.”

FIG. 4B illustrates a graphical user interface 400b including conversational features. The graphical user interface 400b may have a natural language interface. The natural language interface may allow users to manage the Wi-Fi® network by using everyday language, removing the need for technical knowledge. This feature may simplify network control, making it accessible for users of different skill levels. Users may ask the natural language interface to perform tasks like resetting the router, checking the internet speed, or even prioritizing devices with a simple command.

The natural language interface may include a section in which questions for an agent may be asked. The natural language interface may have an “ask agent” button, a “clear chat” button, a microphone button, and/or a sound button. The natural language interface may have a “Reply from Agent” section. The “Reply from Agent” section may provide a history of the chat between the user and the agent. The natural language interface may include a “System Commands for Wi-Fi AP” section which may include commands such as a speed test.

The graphical user interface 400b may allow for voice control. Voice commands may be used to manage the network, providing a hands-free experience. With multiple voice options, including male, female, and a variety of languages, this feature may cater to a diverse set of users, improving accessibility and user experience.

The graphical user interface 400b may allow for Do It Yourself (DIY) Installation Assistance. The conversational interface may act as a guide for users during the setup process. By interacting with the system, users may set up their Wi-Fi® network without needing technical support which may significantly reduce installation time and external assistance.

The graphical user interface 400b may allow for troubleshooting and diagnostics. The graphical user interface may be used to autonomously run diagnostics, perform speed tests, and check device connectivity. When issues are detected, the graphical user interface 400b may allow for automatically sending logs to customer support, speeding up issue resolution.

The graphical user interface 400b may include a connection configuration section. The connection configuration section may include one or more of: (i) stream monitor, (2) access point, (3) load generator, (iv) stream ID, (v) DSCP, (vi) service (Mbps), and/or (vii) support email. Buttons used may include “connect to services,” “change priority,” and “quit.”

The graphical user interface 400b may also include a diagram of the configuration of the network. For example, FIG. 4B shows an access point connected to a router using a wired interface in which the router is connected to the internet using a wired interface. The access point may be connected to a customer laptop, a customer phone/tablet, and/or an office personal computer (PC).

The graphical user interface 400b may allow for user profiles and customization. The graphical user interface 400b may allow users to create multiple profiles, with custom settings tailored to their preferences. These profiles may enable personalized experiences, including bandwidth allocation and device prioritization, providing flexibility and convenience for users in a household.

The graphical user interface 400b may also allow for parental controls. Advanced parental control features enable monitoring and managing children's internet usage. The AP and/or STA may restrict access to inappropriate content, set time limits, and even detect proxy attempts to bypass these restrictions, ensuring a safe online environment for younger users.

Additional parental controls may be implemented. The AP and/or STA may track video streaming and other bandwidth-heavy activities to manage screen time. The AP and/or STA can enforce limits even if proxies or other methods are used to bypass parental controls, ensuring a reliable safety net for parents.

The graphical user interface 400b may allow for flexible service set identifier (SSID) configuration. The graphical user interface 400b provides the ability to configure multiple SSIDs for different use cases, such as guest networks or IoT devices. It can switch between hidden and visible modes based on user preference, ensuring both security and ease of access.

The graphical user interface 400b may include a conversational interface for DIY installation. The conversational interface may not only assist in the installation but also provide real-time feedback, making the process more intuitive for users. The conversational interface may suggest improvements and highlight potential issues during setup.

The home networking experience may include a seamless, voice-driven, browser-based assistant in which no app may be used. By connecting to a Wi-Fi® Access Point and accessing the portal, a browser may be used to diagnose, optimize, and manage the network. The gateway's edge intelligence may be integrated with advanced cloud AI, delivering real-time troubleshooting, optimization, and superior connectivity.

The front end may be device agnostic and easy to access. Users may connect to their Wi-Fi® network and launch the portal on a device without installing an app. The intuitive web-based interface may provide instant, voice-enabled control, diagnostics, and comprehensive network management across operating systems. The portal may have several characteristics including: (1) zero downloads or installations because the portal may be ready to use out of the box, (2) compatibility with IOS, Android, Windows, Mac, Linux, and the like, and (3) voice-activated troubleshooting, device prioritization, and configuration.

The end-to-end system workflow may include one or more of: (1) natural voice interaction, (2) edge and cloud AI orchestration, (3) automated diagnosis and remediation, (4) optimization and self-healing, (5) transparent and secure user experience, and (6) automated self-guided installation.

In relation to natural voice interaction, users may ask questions like “Why is my TV streaming slow?” in their language. The conversational AI may understand context, identify the affected device or application (e.g., Netflix®, YouTube®), and initiate real-time diagnostics.

For the edge and cloud AI orchestration, the on premise gateway may gather device telemetry, collaborating with the cloud AI agent for holistic, data-driven analysis. The cloud AI agent may evaluate options for performance and cost trade-offs while optimizing.

The edge AI may engage in automated diagnosis and remediation. The edge AI may detect and correct issues such as congestion, interference, or bandwidth allocation. The system may apply fixes by reallocating bandwidth or optimizing Wi-Fi® channels on the edge device. Users may receive friendly, real-time feedback: “OK, let me fix it and speed up your TV's Internet.”

The system may optimize and self-heal. The system may learn from live and/or historical data. The edge devices may operate autonomously for low-latency control, while the cloud facilitates learning and optimization when the UI is invoked.

User experiences may be transparent and secure. User interactions may be privacy-focused. That is, sensitive diagnostics may be processed locally. Users may receive clear, jargon-free responses because no technical expertise may be assumed.

As illustrated in the system 400c in FIG. 4C, an automated self-guided installation may be used. The system 400c may include a cloud-computing environment 450, an access point 460, a user equipment 470, a laptop 480 and/or a television 490. The automated self-guided installation may use voice interaction, log analysis, and beamforming-based device positioning to simplify Wi-Fi® setup and optimization. By analyzing signal strength and directionality data, the system may infer the locations of connected devices and recommend optimal placement of the router and clients. This intelligence may extend beyond installation-during regular usage, the system may continue to monitor performance and may prompt users to reorient or relocate devices to maintain optimal coverage and throughput, through intuitive voice-guided experience.

An access point may be used with machine learning and/or AI to increase network performance of a device and/or application. The processing device may receive a user request relating to network performance of a device and/or application. The processing device may identify the device and/or application. The processing device may generate a training set related to the network performance of the device and/or application. The processing device may train a model using the training set. The increase in network performance of the device and/or application may be obtained using the trained model. The training set may include historical and/or live data.

The user request may be received using a graphical user interface and/or via a conversational interface which may use natural voice interaction. The user request may be sent to a cloud computing environment (e.g., via a cellular network). The increase in network performance may be obtained by reallocating bandwidth and/or optimizing a channel.

The processing device of the access point may generate a training set including channel condition patterns. The neural network may be trained using the training set. One or more channels may be selected using the neural network to minimize interference and maximize data throughput.

For example, deep Q-Networks are a type of deep neural network (DNN) that combines traditional Q-Learning, a form of reinforcement learning, with deep neural networks to create systems that can learn to make decisions to maximize a reward signal. They can dynamically learn from the environment to identify the optimal channels with minimal interference.

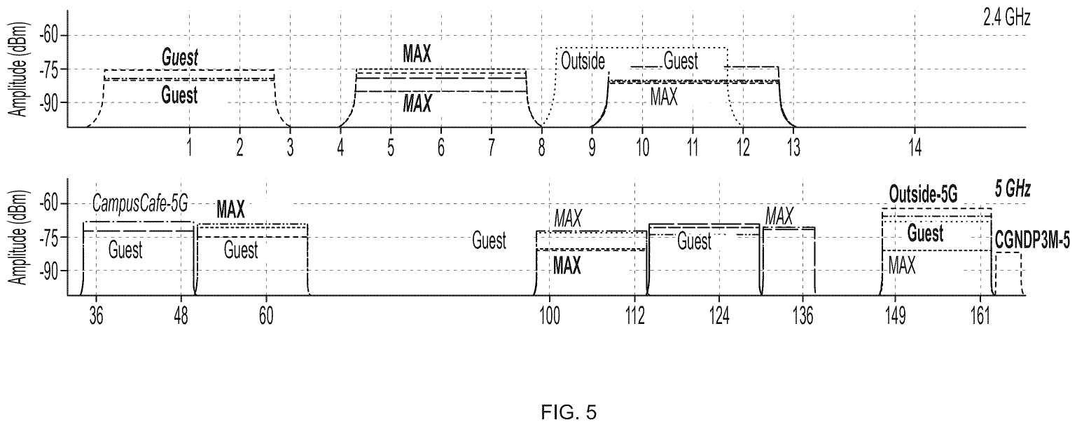

As illustrated in FIG. 5, a graph of the amplitude as a function of time may be graphed. The top graph shows the amplitude as a function of time for a 2.4 GHz signal. The bottom graph shows the amplitude as a function of time for a 5 GHz signal.

Channels may be selected to maximize the signal while reducing the interference. An AP may include a processing device. The processing device may select, at the AP, a channel using a deep neural network (DNN) and Q-Learning. The AP may select the channel to minimize interference.

A STA may include a processing device. The processing device may identify, at the STA, channel condition patterns. The processing device may compute, at the STA, predictive channel conditions based on the channel condition patterns. The processing device may select, at the STA, one or more channels based on the predictive channel conditions. The processing device may scan, at the STA, the one or more channels.

The predictive channel conditions may be computed using reinforcement learning. The predictive channel conditions may be computed based on one or more of throughput, latency, and/or packet loss.

In one example, predictive channel scanning may leverage historical data to anticipate the best channels to scan at specific times, significantly reducing the need for exhaustive scanning. By predicting channel conditions based on patterns, devices can optimize their scanning strategy to avoid congested channels and improve connection times. Predictive scanning can lead to quicker connections and smoother network transitions, enhancing user experience.

In another example, adaptive scanning may use reinforcement learning (RL) to offer a dynamic approach that adapts to real-time conditions. The system learns from the environment and improves its scanning strategy, optimizing for metrics like throughput, latency, and packet loss. This adaptive nature makes it suitable for complex, variable environments where static rules are insufficient.

The STA may compute predictive channel conditions using spectrum sensing data. Use deep learning models for real-time spectrum analysis to predict which channels will likely be free or less congested. This allows for scanning to be focused on the most promising channels rather than sequentially scanning available channels. In environments with fluctuating interference (like near microwave ovens or Bluetooth devices), this approach can prioritize channels that are less likely to be affected by transient noise sources.

AI-optimized channel selection may be implemented. Using AI to analyze the wireless environment, optimal channels may be selected to reduce interference and maximize data throughput. This continuous learning mechanism ensures the network remains at peak performance, even as conditions change.

Adaptive band and channel management may be implemented. The AP and/or STA may dynamically adjust frequency bands and channels to minimize interference, leveraging historical throughput data to improve channel selection. This ensures users connect to the most optimal network environment.

The one or more channels may be in various ranges. For example, the one or more channels may be in a range of the Wi-Fi® 2.4 GHz band (e.g., from about 2.4 GHz to about 2.4835 GHZ.). Alternatively or in addition, the one or more channels may be in a range of a Bluetooth channel (e.g., 2.402 GHz to 2.480 GHz).

In some examples, AI/ML may be used for network management and optimization. AI-based Wi-Fi® scheduling may, by leveraging AI algorithms, predict traffic patterns and dynamically allocate resources to optimize network performance. AI-based Wi-Fi® scheduling may reduce latency, increase throughput, and ensure efficient use of bandwidth based on real-time analysis of network usage.

Local AI/ML algorithms may be used. AI/ML algorithms may be embedded directly within the access point to enable continuous network performance optimization. These algorithms may analyze real-time data to adjust resource allocation, adapt to varying conditions, and improve overall network performance without the need for constant manual intervention.

Intelligent power management may be implemented. Power consumption may be automatically adjusted based on the network demand, reducing energy usage when the network is underutilized. This feature may be beneficial for households that want to minimize energy costs while ensuring high-priority tasks are handled efficiently.

AI-driven network optimization may be implemented. The AP and/or STA may adapt to changing network conditions using AI, providing optimized performance for speed, reliability, and/or efficiency. The AP and/or STA may learn from network usage patterns and user behavior to ensure the best possible experience.

Security enhancements may be implemented. Real-time threat detection and automatic firmware updates may protect the network from vulnerabilities. The AP and/or STA may isolate suspicious devices, keeping the rest of the network secure.

For Wi-Fi® service quality, CNNs may be used for traffic classification and LSTMs may be used for predicting quality over time by learning from data to enhance network performance. These methods may facilitate the intelligent classification and prediction of service quality so that data packets for applications like VOIP and streaming may be prioritized to enhance the user experience. The Wi-Fi® AP may optimize data flows across access categories so that peak performance and reliability is obtained for applications.

Machine learning may be used in anomaly detection. For example, using unsupervised learning algorithms, such as auto-encoders, may be used to identify unusual traffic patterns that may be indicative of network issues or security breaches such as distributed denial of service (DDoS) attacks. Auto-encoders may be trained to reconstruct data and may fail to reconstruct anomalies, which may be detected using the reconstruction error.

Wi-Fi® scheduler enhancements may be effectuated. Predictive analysis may be used to anticipate and manage traffic. Low power may be obtained by using intelligent scheduling. Long short-term memory (LSTM) networks may accurately forecast traffic patterns. LSTM networks may identify complex temporal dependencies by analyzing historical data, significantly enhancing traffic management. LSTM networks may scale when handling a large number (e.g., 250) of clients simultaneously.

AI/ML operating on an edge router may enhance performance, user experience, robustness, and network efficiency. Some of the characteristics may include enhanced gateway and Wi-Fi® functionality such as AI enhanced power management, latency optimizations using AI, Wi-Fi® enabled scheduling, AI link adaptation, self-learning QoS/quality of experience (QoE), or the like.

Analytics and network management may also be enhanced such as network health checks or self diagnostics, use of AI self-learning mesh networks, AI assisted self-installation and fault handling, or wide area network (WAN) spectral analysis (e.g., data over cable service interface specifications (DOCSIS) proactive network maintenance (PNM)).

Various services and user experiences may be enhanced. For example, natural language processing, threat detection, facial recognition, motion detection, AI enabled customer support, and/or a service aware controller may be used to enhance user experience.

The system may have various features. For example, the hardware may operate as a transformer based AI-model. Natural language support may allow users to query issues, request adjustments, and receive real-time voice responses using integrated cloud based cognitive services (e.g., a voice assistant). The Wi-Fi® experience may be enhanced for the end user which may reduce support costs for operators and end users. The implementation may use pre-trained recipes with on-device computing and/or support advanced models with augmented compute using platform processors and/or cloud solutions.

The AI framework may include: (1) an algorithm interface to allow easy integration, (2) canned recipes for common use cases (e.g., video, gaming), (3) low-level ML-aware firmware integrated with silicon features, and (4) optimized silicon features such as radio, buffers, scheduler, queues, scalable cycles, or the like.

A home gateway use case may enhance QoS and multi-user use using one or more of: (1) natural language interaction with the user, (2) dynamic management of QoS, (3) managing key performance indicators for applications dynamically, (4) minimizing latency for latency-sensitive applications, and (5) mitigating co-existence issues.

Inference and AI may be operated without a dedicated neural processing unit. For example, there may be offloading of data which may allow for enhanced processing power (e.g., 2/4 atom cores) which may allow for parallel execution of multiple ML models. X86 vectoring hardware may be used. Auxiliary processors may be used for data reduction. There may be data path intimacy to facilitate AI decisions (e.g., system on chip (SoC) and sub-systems such as passive optical network (PON), or the like). Coherent memory access may be used. The x86 may be optimized for open VINO.

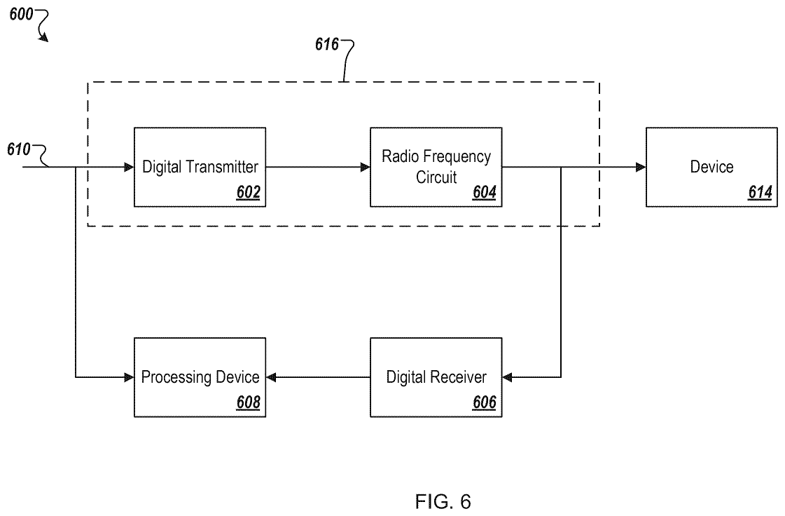

FIG. 6 illustrates a block diagram of an example communication system 600, in accordance with at least one example described in the present disclosure. The communication system 600 may include a digital transmitter 602, a radio frequency circuit 604, a device 614, a digital receiver 606, and a processing device 608. The digital transmitter 602 and the processing device may be configured to receive a baseband signal via connection 610. A transceiver 616 may comprise the digital transmitter 602 and the radio frequency circuit 604.

In some examples, the communication system 600 may include a system of devices that may be configured to communicate with one another via a wired or wireline connection. For example, a wired connection in the communication system 600 may include one or more Ethernet cables, one or more fiber-optic cables, and/or other similar wired communication mediums. Alternatively, or additionally, the communication system 600 may include a system of devices that may be configured to communicate via one or more wireless connections. For example, the communication system 600 may include one or more devices configured to transmit and/or receive radio waves, microwaves, ultrasonic waves, optical waves, electromagnetic induction, and/or similar wireless communications. Alternatively, or additionally, the communication system 600 may include combinations of wireless and/or wired connections. In these and other examples, the communication system 600 may include one or more devices that may be configured to obtain a baseband signal, perform one or more operations to the baseband signal to generate a modified baseband signal, and transmit the modified baseband signal, such as to one or more loads.

In some examples, the communication system 600 may include one or more communication channels that may communicatively couple systems and/or devices included in the communication system 600. For example, the transceiver 616 may be communicatively coupled to the device 614.

In some examples, the transceiver 616 may be configured to obtain a baseband signal. For example, as described herein, the transceiver 616 may be configured to generate a baseband signal and/or receive a baseband signal from another device. In some examples, the transceiver 616 may be configured to transmit the baseband signal. For example, upon obtaining the baseband signal, the transceiver 616 may be configured to transmit the baseband signal to a separate device, such as the device 614. Alternatively, or additionally, the transceiver 616 may be configured to modify, condition, and/or transform the baseband signal in advance of transmitting the baseband signal. For example, the transceiver 616 may include a quadrature up-converter and/or a digital to analog converter (DAC) that may be configured to modify the baseband signal. Alternatively, or additionally, the transceiver 616 may include a direct radio frequency (RF) sampling converter that may be configured to modify the baseband signal.

In some examples, the digital transmitter 602 may be configured to obtain a baseband signal via connection 610. In some examples, the digital transmitter 602 may be configured to up-convert the baseband signal. For example, the digital transmitter 602 may include a quadrature up-converter to apply to the baseband signal. In some examples, the digital transmitter 602 may include an integrated digital to analog converter (DAC). The DAC may convert the baseband signal to an analog signal, or a continuous time signal. In some examples, the DAC architecture may include a direct RF sampling DAC. In some examples, the DAC may be a separate element from the digital transmitter 602.

In some examples, the transceiver 616 may include one or more subcomponents that may be used in preparing the baseband signal and/or transmitting the baseband signal. For example, the transceiver 616 may include an RF front end (e.g., in a wireless environment) which may include a power amplifier (PA), a digital transmitter (e.g., 602), a digital front end, an Institute of Electrical and Electronics Engineers (IEEE) 1588v2 device, a Long-Term Evolution (LTE) physical layer (L-PHY), an (S-plane) device, a management plane (M-plane) device, an Ethernet media access control (MAC)/personal communications service (PCS), a resource controller/scheduler, and the like. In some examples, a radio (e.g., a radio frequency circuit 604) of the transceiver 616 may be synchronized with the resource controller via the S-plane device, which may contribute to high-accuracy timing with respect to a reference clock.

In some examples, the transceiver 616 may be configured to obtain the baseband signal for transmission. For example, the transceiver 616 may receive the baseband signal from a separate device, such as a signal generator. For example, the baseband signal may come from a transducer configured to convert a variable into an electrical signal, such as an audio signal output of a microphone picking up a speaker's voice. Alternatively, or additionally, the transceiver 616 may be configured to generate a baseband signal for transmission. In these and other examples, the transceiver 616 may be configured to transmit the baseband signal to another device, such as the device 614.

In some examples, the device 614 may be configured to receive a transmission from the transceiver 616. For example, the transceiver 616 may be configured to transmit a baseband signal to the device 614.

In some examples, the radio frequency circuit 604 may be configured to transmit the digital signal received from the digital transmitter 602. In some examples, the radio frequency circuit 604 may be configured to transmit the digital signal to the device 614 and/or the digital receiver 606. In some examples, the digital receiver 606 may be configured to receive a digital signal from the RF circuit and/or send a digital signal to the processing device 608.

In some examples, the processing device 608 may be a standalone device or system, as illustrated. Alternatively, or additionally, the processing device 608 may be a component of another device and/or system. For example, in some examples, the processing device 608 may be included in the transceiver 616. In instances in which the processing device 608 is a standalone device or system, the processing device 608 may be configured to communicate with additional devices and/or systems remote from the processing device 608, such as the transceiver 616 and/or the device 614. For example, the processing device 608 may be configured to send and/or receive transmissions from the transceiver 616 and/or the device 614. In some examples, the processing device 608 may be combined with other elements of the communication system 600.

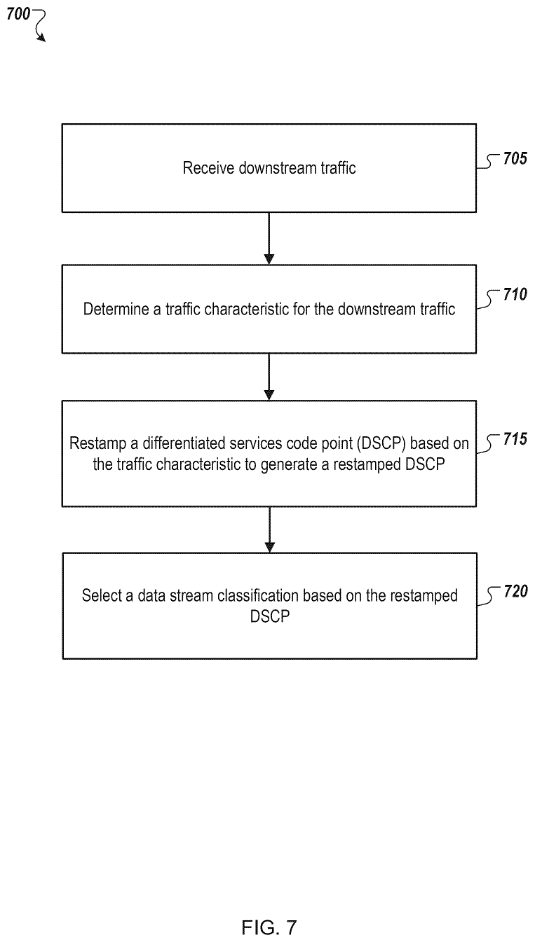

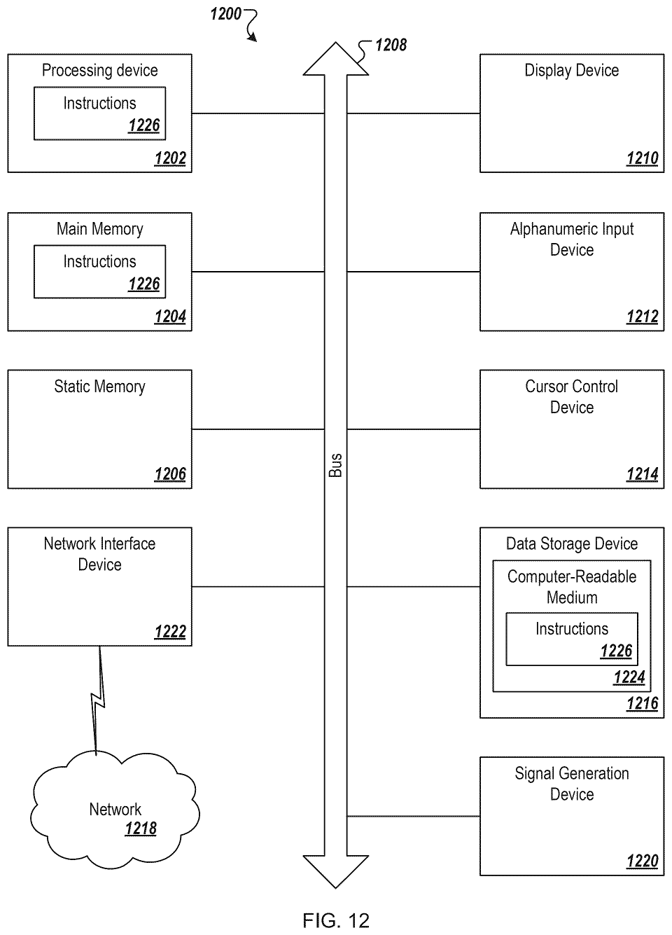

FIG. 7 illustrates a process flow of an example method 700, in accordance with at least one example described in the present disclosure. The method 700 may be arranged in accordance with at least one example described in the present disclosure. The method 700 may be performed by processing logic that may include hardware (circuitry, dedicated logic, etc.), software (such as is run on a computer system or a dedicated machine), or a combination of both, which processing logic may be included in the processing device 1202 of FIG. 12, the communication system 600 of FIG. 6, or another device, combination of devices, or systems.

The method 700 may begin at block 705 where the processing logic may receive, at the AP, downstream traffic. In block 710, the processing logic may determine, at the AP, a traffic characteristic for the downstream traffic. In block 715, the processing logic may restamp, at the AP, a differentiated services code point (DSCP) based on the traffic characteristic to generate a restamped DSCP. In block 720, the processing logic may select, at the AP, a data stream classification based on the restamped DSCP.

The processing logic may adjust the data stream classification based on input from a user. The processing logic may adjust the data stream classification based on a network condition. The downstream traffic may be received via one or more of a fiber or a cable. The processing logic may generate a wireless signal for transmission using the data stream classification. The processing logic may select the data stream classification using a traffic identifier (TID). The traffic characteristic may be determined using artificial intelligence. The traffic characteristic may be determined using machine learning.

Modifications, additions, or omissions may be made to the method 700 without departing from the scope of the present disclosure. For example, in some examples, the method 700 may include any number of other components that may not be explicitly illustrated or described.

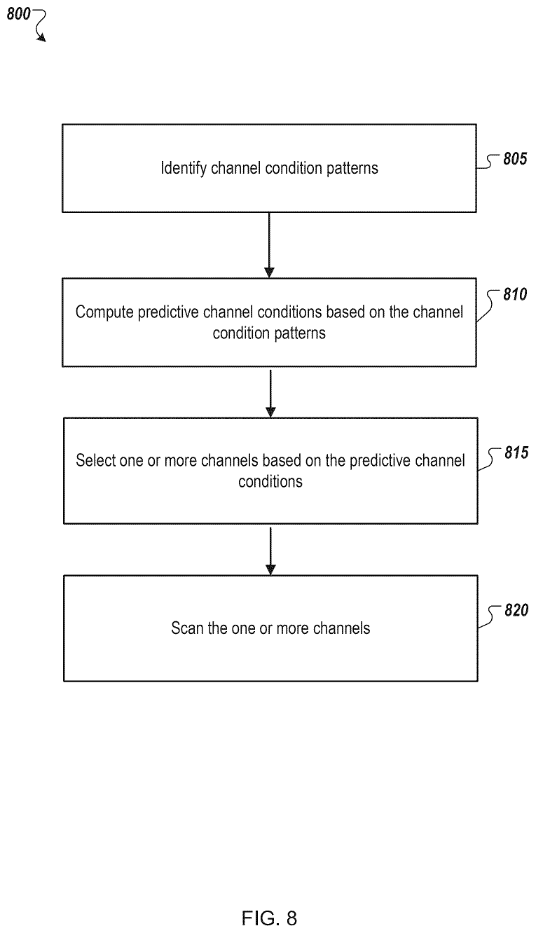

FIG. 8 illustrates a process flow of an example method 800, in accordance with at least one example described in the present disclosure. The method 800 may be arranged in accordance with at least one example described in the present disclosure.

The method 800 may be performed by processing logic that may include hardware (circuitry, dedicated logic, etc.), software (such as is run on a computer system or a dedicated machine), or a combination of both, which processing logic may be included in the processing device 1202 of FIG. 12, the communication system 600 of FIG. 6, or another device, combination of devices, or systems.

The method 800 may begin at block 805 where the processing logic may identify, at the STA, channel condition patterns. At block 810, the processing logic may compute, at the STA, predictive channel conditions based on the channel condition patterns. At block 815, the processing logic may select, at the STA, one or more channels based on the predictive channel conditions. At block 820, the processing logic may scan, at the STA, the one or more channels.

The predictive channel conditions may be computed using reinforcement learning. The predictive channel conditions may be computed based on throughput. The predictive channel conditions may be computed based on latency. The predictive channel conditions may be computed based on packet loss. The predictive channel conditions may be computed using spectrum sensing data. The one or more channels may be in a range of from about 2.4 GHz to about 2.4835 GHz. The one or more channels may be present in a range of from about 2.402 GHz to about 2.480 GHz.

Modifications, additions, or omissions may be made to the method 800 without departing from the scope of the present disclosure. For example, in some examples, the method 800 may include any number of other components that may not be explicitly illustrated or described.

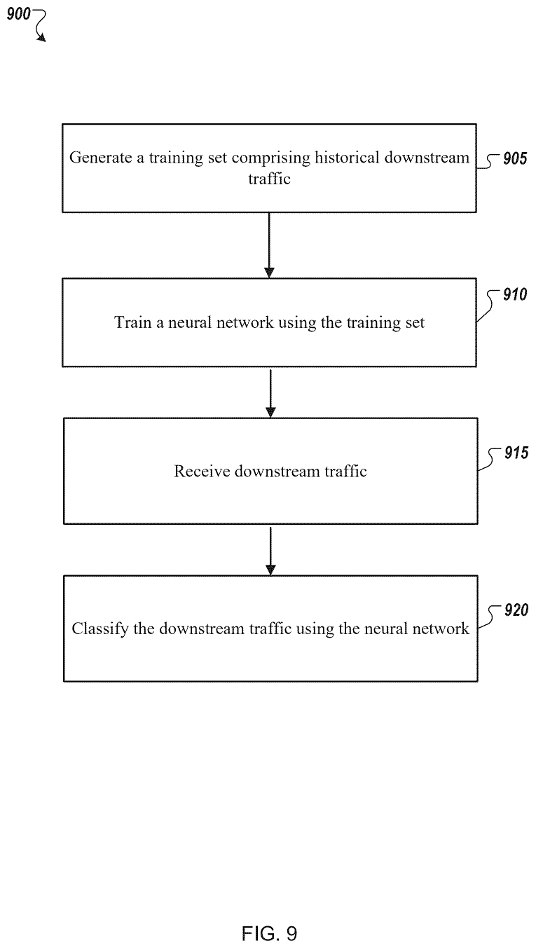

FIG. 9 illustrates a process flow of an example method 900, in accordance with at least one example described in the present disclosure. The method 900 may be arranged in accordance with at least one example described in the present disclosure.

The method 900 may be performed by processing logic that may include hardware (circuitry, dedicated logic, etc.), software (such as is run on a computer system or a dedicated machine), or a combination of both, which processing logic may be included in the processing device 1202 of FIG. 12, the communication system 600 of FIG. 6, or another device, combination of devices, or systems.

The method 900 may begin at block 905 where the processing logic may generate, at the AP, a training set comprising historical downstream traffic. At block 910, the processing logic may train, at the AP, a neural network using the training set. At block 915, the processing logic may receive, at the AP, downstream traffic. At block 920, the processing logic may classify, at the AP, the downstream traffic using the neural network.

The processing logic may predict, at the AP, a quality of service (QoS) for the downstream traffic using the neural network. The neural network may be one or more of a convolutional neural network (CNN) or a long short-term memory (LSTM) recurrent neural network (RNN). The processing logic may restamp, at the AP, a differentiated services code point (DSCP) based on a traffic characteristic to generate a restamped DSCP; and select, at the AP, a data stream classification based on the restamped DSCP.

The processing logic may detect, at the AP, an anomaly in the downstream traffic using the neural network. The processing logic may predict, at the AP, power consumption based on the downstream traffic to generate a predicted power consumption; and adjust, at the AP, the power consumption based on the predicted power consumption.

The processing logic may receive, at the AP, a user request to prioritize an application; and adjust, at the AP, a network performance for the application using the neural network. The processing logic may reduce, at the AP, a latency for the downstream traffic using the neural network.

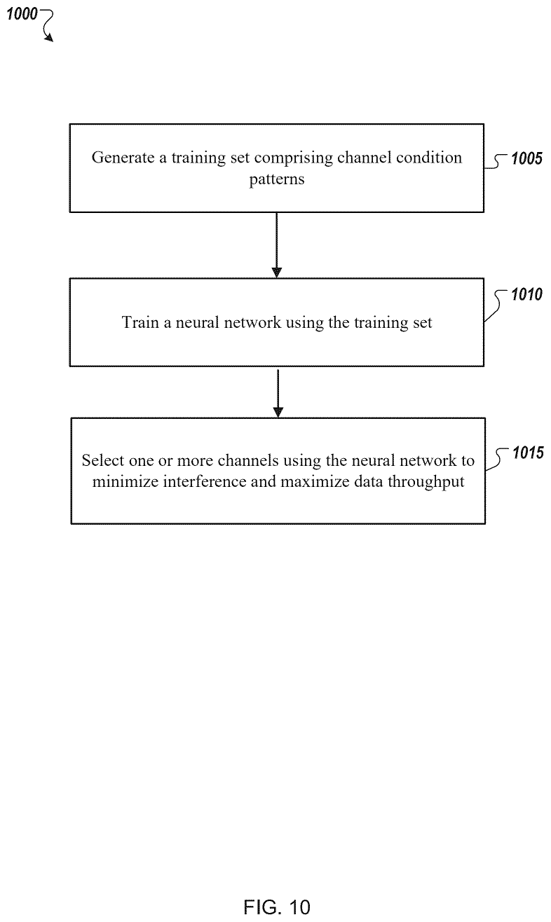

FIG. 10 illustrates a process flow of an example method 1000, in accordance with at least one example described in the present disclosure. The method 1000 may be arranged in accordance with at least one example described in the present disclosure.

The method 1000 may be performed by processing logic that may include hardware (circuitry, dedicated logic, etc.), software (such as is run on a computer system or a dedicated machine), or a combination of both, which processing logic may be included in the processing device 1202 of FIG. 12, the communication system 600 of FIG. 6, or another device, combination of devices, or systems.

The method 1000 may begin at block 1005 where the processing logic may generate, at the AP, a training set comprising channel condition patterns. At block 1010, the processing logic may train, at the AP, a neural network using the training set. At block 1015, the processing logic may select, at the AP, one or more channels using the neural network to minimize interference and maximize data throughput.

The neural network may be a deep neural network including a deep Q-network. The channel condition patterns may be based on one or more of throughput, latency, or packet loss. The training set may include spectrum sensing data. The processing logic may dynamically adjust one or more frequency bands or one or more channels using the neural network.

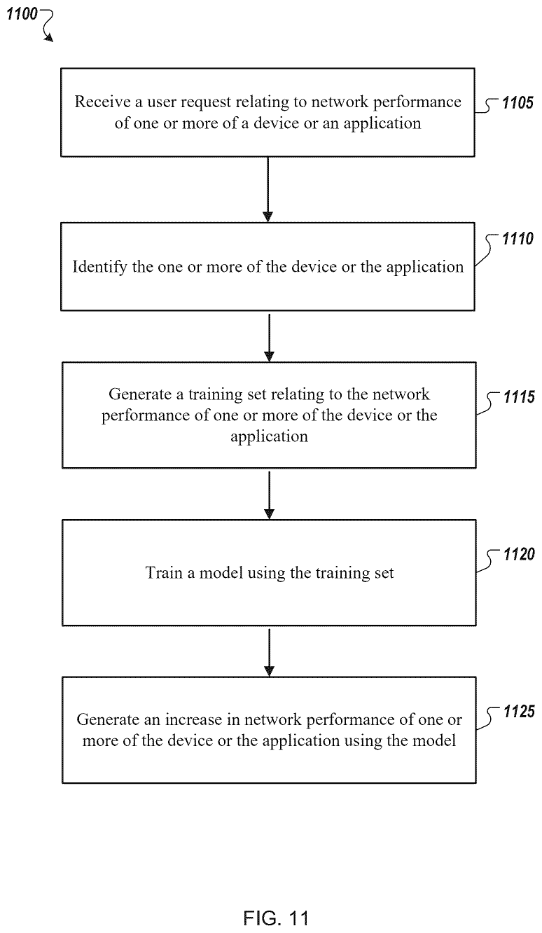

FIG. 11 illustrates a process flow of an example method 1100, in accordance with at least one example described in the present disclosure. The method 1100 may be arranged in accordance with at least one example described in the present disclosure.

The method 1100 may be performed by processing logic that may include hardware (circuitry, dedicated logic, etc.), software (such as is run on a computer system or a dedicated machine), or a combination of both, which processing logic may be included in the processing device 1202 of FIG. 12, the communication system 600 of FIG. 6, or another device, combination of devices, or systems.

The method 1100 may begin at block 1105 where the processing logic may receive, at the AP, a user request relating to network performance of one or more of a device or an application. At block 1110, the processing logic may identify, at the AP, the one or more of the device or the application. At block 1115, the processing logic may generate, at the AP, a training set relating to the network performance of one or more of the device or the application. At block 1120, the processing logic may train, at the AP, a model using the training set. At block 1125, the processing logic may generate, at the AP, an increase in network performance of one or more of the device or the application using the model.

The user request may be received using one or more of a graphical user interface or a conversational interface. The one or more of the graphical user interface or the conversational interface may allow natural voice interaction by a user. The processing logic may determine, at the AP, locations of one or more connected devices by analyzing one or more of signal strength or directionality data; and generate, at the AP, recommended locations for the one or more connected devices to maximize coverage and throughput using the model. The processing logic may send, from the AP to a cloud-computing environment, the user request. The processing logic may generate the increase in network performance by one or more of reallocating bandwidth or optimizing a channel. The training set may include one or more of historical or live data.

For simplicity of explanation, methods and/or process flows described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

FIG. 12 illustrates a diagrammatic representation of a machine in the example form of a computing device 1200 within which a set of instructions, for causing the machine to perform any one or more of the methods discussed herein, may be executed. The computing device 1200 may include a rackmount server, a router computer, a server computer, a mainframe computer, a laptop computer, a tablet computer, a desktop computer, or any computing device with at least one processor, etc., within which a set of instructions, for causing the machine to perform any one or more of the methods discussed herein, may be executed. In alternative examples, the machine may be connected (e.g., networked) to other machines in a local area network (LAN), an intranet, an extranet, or the Internet. The machine may operate in the capacity of a server machine in client-server network environment. Further, while only a single machine is illustrated, the term “machine” may also include any collection of machines that individually or jointly execute a set (or multiple sets) of instructions to perform any one or more of the methods discussed herein.

The example computing device 1200 includes a processing device (e.g., a processor) 1202, a main memory 1204 (e.g., read-only memory (ROM), flash memory, dynamic random access memory (DRAM) such as synchronous DRAM (SDRAM)), a static memory 1206 (e.g., flash memory, static random access memory (SRAM)) and a data storage device 1216, which communicate with each other via a bus 1208.

Processing device 1202 represents one or more general-purpose processing devices such as a microprocessor, central processing unit, or the like. More particularly, the processing device 1202 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 1202 may also include one or more special-purpose processing devices such as an application specific integrated circuit (ASIC), a field programmable gate array (FPGA), a digital signal processor (DSP), network processor, or the like. The processing device 1202 is configured to execute instructions 1226 for performing the operations and steps discussed herein.

The computing device 1200 may further include a network interface device 1222 which may communicate with a network 1218. The computing device 1200 also may include a display device 1210 (e.g., a liquid crystal display (LCD) or a cathode ray tube (CRT)), an alphanumeric input device 1212 (e.g., a keyboard), a cursor control device 1214 (e.g., a mouse) and a signal generation device 1220 (e.g., a speaker). In at least one example, the display device 1210, the alphanumeric input device 1212, and the cursor control device 1214 may be combined into a single component or device (e.g., an LCD touch screen).

The data storage device 1216 may include a computer-readable storage medium 1224 on which is stored one or more sets of instructions 1226 embodying any one or more of the methods or functions described herein. The instructions 1226 may also reside, completely or at least partially, within the main memory 1204 and/or within the processing device 1202 during execution thereof by the computing device 1200, the main memory 1204 and the processing device 1202 also constituting computer-readable media. The instructions may further be transmitted or received over a network 1218 via the network interface device 1222.

While the computer-readable storage medium 1224 is shown in an example to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media.

In some examples, the different components, modules, engines, and services described herein may be implemented as objects or processes that execute on a computing system (e.g., as separate threads). While some of the systems and methods described herein are generally described as being implemented in software (stored on and/or executed by hardware), specific hardware implementations or a combination of software and specific hardware implementations are also possible and contemplated.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although examples of the present disclosure have been described in detail, it should be understood that the various changes, substitutions, and alterations could be made hereto without departing from the spirit and scope of the present disclosure.

What is claimed is:

1. An access point (AP), comprising:
a processing device operable to:
generate, at the AP, a training set comprising historical downstream traffic;
train, at the AP, a neural network using the training set;
receive, at the AP, downstream traffic; and
classify, at the AP, the downstream traffic using the neural network.

2. The AP of claim 1, wherein the processing device is further operable to predict, at the AP, a quality of service (QoS) for the downstream traffic using the neural network.

3. The AP of claim 1, wherein the neural network is one or more of a convolutional neural network (CNN) or a long short-term memory (LSTM) recurrent neural network (RNN).

4. The AP of claim 1, wherein the processing device is further operable to:
restamp, at the AP, a differentiated services code point (DSCP) based on a traffic characteristic to generate a restamped DSCP; and
select, at the AP, a data stream classification based on the restamped DSCP.

5. The AP of claim 1, wherein the processing device is further operable to detect, at the AP, an anomaly in the downstream traffic using the neural network.

6. The AP of claim 1, wherein the processing device is further operable to:
predict, at the AP, power consumption based on the downstream traffic to generate a predicted power consumption; and
adjust, at the AP, the power consumption based on the predicted power consumption.

7. The AP of claim 1, wherein the processing device is further operable to:
receive, at the AP, a user request to prioritize an application; and
adjust, at the AP, a network performance for the application using the neural network.

8. The AP of claim 1, wherein the processing device is further operable to:
reduce, at the AP, a latency for the downstream traffic using the neural network.

9. An access point (AP), comprising:
a processing device operable to:
generate, at the AP, a training set comprising channel condition patterns;
train, at the AP, a neural network using the training set; and
select, at the AP, one or more channels using the neural network to minimize interference and maximize data throughput.

10. The AP of claim 9, wherein the neural network is a deep neural network comprising a deep Q-network.

11. The AP of claim 9, wherein the channel condition patterns are based on one or more of throughput, latency, or packet loss.

12. The AP of claim 9, wherein the training set comprises spectrum sensing data.

13. The AP of claim 9, wherein the processing device is further operable to dynamically adjust one or more frequency bands or one or more channels using the neural network.

14. An access point (AP), comprising:
a processing device operable to:
receive, at the AP, a user request relating to network performance of one or more of a device or an application;
identify, at the AP, the one or more of the device or the application;
generate, at the AP, a training set relating to the network performance of one or more of the device or the application;
train, at the AP, a model using the training set; and
generate, at the AP, an increase in network performance of one or more of the device or the application using the model.

15. The AP of claim 14, wherein the user request is received using one or more of a graphical user interface or a conversational interface.

16. The AP of claim 15, wherein the one or more of the graphical user interface or the conversational interface allows natural voice interaction by a user.

17. The AP of claim 14, wherein the processing device is further operable to:
determine, at the AP, locations of one or more connected devices by analyzing one or more of signal strength or directionality data; and
generate, at the AP, recommended locations for the one or more connected devices to maximize coverage and throughput using the model.

18. The AP of claim 14, wherein the processing device is further operable to send, from the AP to a cloud-computing environment, the user request.

19. The AP of claim 14, wherein the processing device is further operable to generate the increase in network performance by one or more of reallocating bandwidth or optimizing a channel.

20. The AP of claim 14, wherein the training set comprises one or more of historical or live data.
